(19) United States
(12) Patent Application Publication
(10) Pub. No.: US 2023/0275977 A1
(43) Pub. Date: Aug. 31, 2023

(54) METHODS, SYSTEMS, AND APPARATUSES FOR SIGNALING SERVER-ASSOCIATED DELAYS IN CONTENT DELIVERY

(71) Applicant: Comcast Cable Communications, LLC, Philadelphia, PA (US)

(72) Inventors: Ali C. Begen, Konya (TR); Yasser Syed, Philadelphia, PA (US); Alexander Giladi, Denver, CO (US)

(21) Appl. No.: 18/175,877

(22) Filed: Feb. 28, 2023

Related U.S. Application Data
(60) Provisional application No. 63/314,840, filed on Feb. 28, 2022.

(51) Int. Cl. H04L 67/61; H04L 43/0852

(52) U.S. Cl. CPC H04L 67/61; H04L 43/0852

(57) ABSTRACT

Methods, systems, and apparatuses for signaling server-associated delays in content delivery are described herein. Client devices in a content delivery network may use adaptation logic when requesting content. The adaptation logic may account for network conditions existing upstream of the client devices in the content delivery network. For example, content sources may provide content to the client devices along with one or more parameters that indicate upstream network conditions. These parameters may enable the client devices to use the adaptation logic more effectively when making rate adaptation decisions.

### CROSS-REFERENCE TO RELATED PATENT APPLICATION

This application claims priority to U.S. Provisional Application Number 63/314,840, filed on Feb. 28, 2022, the entirety of which is incorporated by reference herein.

### BACKGROUND

Content may be available for client devices at a variety of representations—each having a different resolution and/or bitrate. Client devices may be configured to switch between representations and/or switch between content sources to prevent content output from stalling, pausing, etc., when suboptimal network conditions or other content delivery constraints are present. These and other considerations are discussed herein.

### SUMMARY

It is to be understood that both the following general description and the following detailed description are exemplary and explanatory only and are not restrictive. This summary is not intended to identify critical or essential features, but merely to summarize certain features and variations. Methods, systems, and apparatuses for signaling server-associated delays in content delivery are described herein. Client devices in a content delivery network may use rate adaptation logic (adaptation logic in short) when requesting content. For example, the adaptation logic may facilitate a client device that is experiencing optimal network conditions to request a representation of content having a higher bitrate/quality level as compared to another client device that may be experiencing suboptimal network conditions. The adaptation logic may account for network conditions existing upstream of the client devices in the content delivery network. For example, content sources may provide content to the client devices along with one or more parameters that indicate upstream network conditions, such as processing delays or cache misses. These parameters may enable the client devices to use the adaptation logic more effectively when making rate adaptation decisions (e.g., requesting a higher or lower bitrate based on network conditions). Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1 shows an example system;

FIG. 2A shows an example workflow for content delivery;

FIG. 2B shows an example workflow for content delivery;

FIG. 2C shows an example workflow for content delivery;

FIG. 2D shows an example workflow for content delivery;

FIG. 3 shows an example system;

FIG. 4 shows a flowchart for an example method;

FIG. 5 shows a flowchart for an example method;

FIG. 6 shows a flowchart for an example method; and

FIG. 7 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text, and/or graphics, which may be but is not limited to electronic representations of videos, movies, or other multimedia, which may be but is not limited to data files adhering to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC) or some other video file format, whether such format is presently known or developed in the future. The content items described herein may be electronic representations of music, spoken words, or other audio, which may be but is not limited to data files adhering to MPEG-1 audio, MPEG-2 audio, MPEG-2 and MPEG-4 advanced audio coding, MPEG-H, AC-3 (Dolby Digital), E-AC-3 (Dolby Digital Plus), AC-4, Dolby Atmos®, DTS®, and/or any other format configured to store electronic audio, whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio. This detailed description may refer to a given entity performing some action. It should be understood that this language may in some cases mean that a system (e.g., a computer) owned and/or controlled by the given entity is actually performing the action.

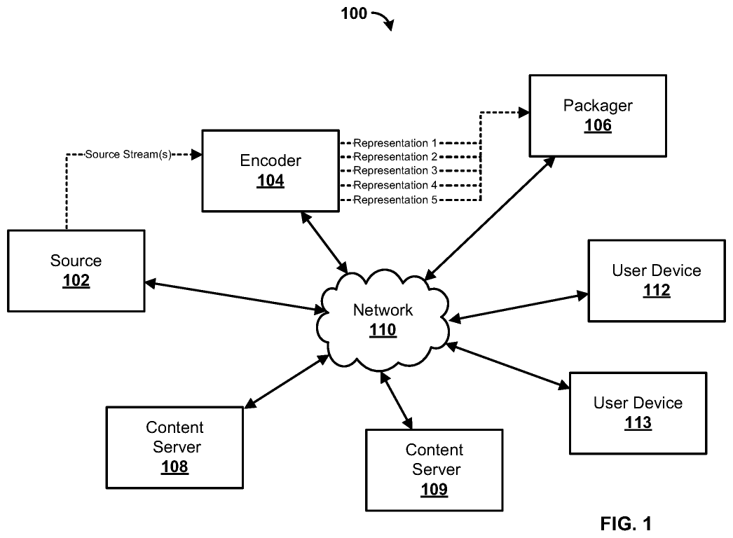

FIG. 1 shows an example system 100 for signaling server-associated delays in content delivery. The system 100 may comprise a plurality of computing devices/entities in communication via a network 110. The network 110 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 110 via a variety of transmission paths, including wireless paths (e.g., satellite paths, Wi-Fi paths, cellular paths, etc.) and terrestrial paths (e.g., wired paths, a direct feed source via a direct line, etc.). The network 110 may comprise public networks, private networks, wide area networks (e.g., Internet), local area networks, and/or the like. The network 110 may comprise a content access network, content distribution network, and/or the like. The network 110 may be configured to provide content from a variety of sources using a variety of network paths, protocols, devices, and/or the like. The content delivery network and/or content access network may be managed (e.g., deployed, serviced) by a content provider, a service provider, and/or the like. The network 110 may deliver content items from a source(s) to a user device(s).

The system 100 may comprise a source 102, such as a server or other computing device. The source 102 may receive source streams for a plurality of content items. The source streams may be live streams (e.g., a linear content stream) and/or video-on-demand (VOD) streams. The live streams may comprise, for example, low-latency (“LL”) live streams. The source 102 may receive the source streams from an external server or device (e.g., a stream capture source, a data storage device, a media server, etc.). The source 102 may receive the source streams via a wired or wireless network connection, such as the network 110 or another network (not shown).

The source 102 may comprise a headend, a video-on-demand server, a cable modem termination system, and/or the like. The source 102 may provide content (e.g., video, audio, games, applications, data) and/or content items (e.g., video, streaming content, movies, shows/programs, etc.) to user devices. The source 102 may provide streaming media, such as live content, on-demand content (e.g., video-on-demand), content recordings, and/or the like. The source 102 may be managed by third-party content providers, service providers, online content providers, over-the-top content providers, and/or the like. A content item may be provided via a subscription, by individual item purchase or rental, and/or the like. The source 102 may be configured to provide content items via the network 110. Content items may be accessed by user devices via applications, such as mobile applications, television applications, set-top box applications, gaming device applications, and/or the like. An application may be a custom application (e.g., by a content provider, for a specific device), a general content browser (e.g., a web browser), an electronic program guide, and/or the like.

The source 102 may provide uncompressed content items, such as raw video data, comprising one or more portions (e.g., frames/slices, groups of pictures (GOP), coding units (CU), coding tree units (CTU), etc.). It should be noted that although a single source 102 is shown in FIG. 1, this is not to be considered limiting. In accordance with the described techniques, the system 100 may comprise a plurality of sources 102, each of which may receive any number of source streams.

The system 100 may comprise an encoder 104, such as a video encoder, a content encoder, etc. The encoder 104 may be configured to encode one or more source streams received via the source 102 into a plurality of content items/streams at various bitrates (e.g., various representations/quality levels). For example, the encoder 104 may be configured to encode a source stream for a content item at varying bitrates for corresponding representations (e.g., versions/quality levels) of a content item for adaptive bitrate streaming. As shown in FIG. 1, the encoder 104 may encode a source stream into Representations 1-5. It is to be understood that the FIG. 1 shows five representations for explanation purposes only. The encoder 104 may be configured to encode a source stream into fewer or greater representations. Representation 1 may be associated with a first resolution (e.g., 480p) and/or a first bitrate (e.g., 4 Mbps). Representation 2 may be associated with a second resolution (e.g., 720p) and/or a second bitrate (e.g., 5 Mbps). Representation 3 may be associated with a third resolution (e.g., 1080p) and/or a third bitrate (e.g., 6 Mbps). Representation 4 may be associated with a fourth resolution (e.g., 4K) and/or a first bitrate (e.g., 10 Mbps). Representation 5 may be associated with a fifth resolution (e.g., 8K) and/or a fifth bitrate (e.g., 15 Mbps). Other examples resolutions and/or bitrates are possible.

The system 100 may comprise a packager 106. The packager 106 may be configured to receive one or more content items/streams from the encoder 104. The packager 106 may be configured to prepare content items/streams for distribution. For example, the packager 106 may be configured to convert encoded content items/streams into a plurality of content fragments. The packager 106 may be configured to provide content items/streams according to adaptive bitrate streaming. For example, the packager 106 may be configured to convert encoded content items/streams at various representations into one or more adaptive bitrate streaming formats, such as Apple HTTP Live Streaming (HLS), Microsoft Smooth Streaming, Adobe HTTP Dynamic Streaming (HDS), MPEG DASH, and/or the like. The packager 106 may pre-package content items/streams and/or provide packaging in real-time as content items/streams are requested by user devices, such as a user device 112 and a user device 113. The user devices 112 and 113 may each be a content/media player, a set-top box, a client device, a smart device, a mobile device, a user device, etc. Though only two user devices are shown in FIG. 1, it is to be understood that the system 100 may comprise fewer or greater user devices.

The system 100 may comprise a content server 108. The content server 108 may be configured to receive requests for content, such as content items/streams. The content server 108 may identify a location of a requested content item and provide the content item—or a portion thereof—to a device requesting the content, such as the user device 112 and/or the user device 113. The content server 108 may comprise—or be a part of—a content origin(s), a mezzanine feed(s), etc. The content server 108 may be configured to provide a communication session with a requesting device, such as the user device 112, based on HTTP, FTP, or other protocols. The content server 108 may be one of a plurality of content servers distributed across the system 100. The content server 108 may be located in a region proximate to the user device 112. A request for a content stream/item from the user device 112 may be directed to the content server 108 (e.g., due to the location and/or network conditions). The content server 108 may be configured to deliver content streams/items to the user device 112 in a specific format requested by the user device 112. The content server 108 may be configured to provide the user device 112 with a manifest file (e.g., or other index file describing portions of the content) corresponding to a content stream/item. The content server 108 may be configured to provide streaming content (e.g., unicast, multicast) to the user device 112. The content server 108 may be configured to provide a file transfer and/or the like to the user device 112. The content server 108 may cache or otherwise store content (e.g., frequently requested content) to enable faster delivery of content items to users. The content server 108 may receive a request for a content item, such as a request for high-resolution video and/or the like. The content server 108 may receive the request for the content item from the user device 112. As further described herein, the content server 108 may be capable of sending (e.g., to the user device 112) one or more portions of the content item at varying bitrates (e.g., Representations 1-5).

The system 100 may comprise a content server 109. The content server 109 may be configured to receive requests for content, such as content items/streams. The content server 109 may identify a location of a requested content item and provide the content item—or a portion thereof—to a device requesting the content, such as the user device 112 and/or the user device 113. The content server 109 may comprise—or be a part of—a content origin(s), a mezzanine feed(s), etc. The content server 109 may be configured to provide a communication session with a requesting device, such as the user device 112 and/or the user device 113, based on HTTP, FTP, or other protocols. The content server 109 may be one of a plurality of content servers distributed across the system 100. The content server 109 may be located in a region proximate to the user device 112 and/or the user device 113. A request for a content stream/item from the user device 112 and/or the user device 113 may be directed to the content server 109 (e.g., due to the location and/or network conditions). The content server 109 may be configured to deliver content streams/items to the user device 112 and/or the user device 113 in a specific format requested by the user device 112 and/or the user device 113. The content server 109 may be configured to provide the user device 112 and/or the user device 113 with a manifest file (e.g., or other index file describing portions of the content) corresponding to a content stream/item. The content server 109 may be configured to provide streaming content (e.g., unicast, multicast) to the user device 112 and/or the user device 113. The content server 109 may be configured to provide a file transfer and/or the like to the user device 112 and/or the user device 113. The content server 109 may cache or otherwise store content (e.g., frequently requested content) to enable faster delivery of content items to users. The content server 109 may receive a request for a content item, such as a request for high-resolution video and/or the like. The content server 109 may receive the request for the content item from the user device 112 and/or the user device 113. As further described herein, the content server 109 may be capable of sending (e.g., the user device 112 and/or the user device 113) one or more portions of the content item at varying bitrates (e.g., Representations 1-5). Though only two content servers are shown in FIG. 1, it is to be understood that the system 100 may comprise fewer or greater content servers.

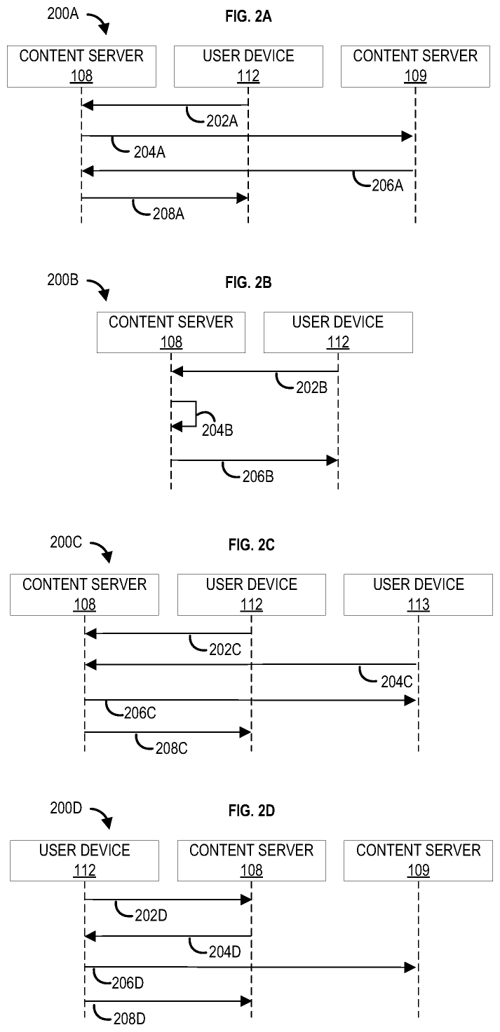

FIGS. 2A-2D show example workflows 200A-200D for content delivery. Any one (or more) of the workflows 200A-200D may be implemented by the system 100 for content delivery. For example, as further described herein, the workflow 200B may be implemented by the system 100 as part of the workflow 200A when a processing delay(s) related to requested content is encountered by the system 100. As another example, the workflow 200C may be implemented by the system 100 as part of any of the workflows 200A, 200B, or 200D. Other examples and combinations are possible as well.

FIG. 2A shows an example workflow 200A for content delivery. The workflow 200A may be implemented by the system 100 when requested content is not available at a device/component of the system 100 that receives the request (e.g., from a client/user device). At step 202A, the user device 112 may send a request for content. The user device 112 may send the request to the content server 108 directly. Additionally, or in the alternative, the request may be sent from the user device 112 to one or more intermediary devices/components of the system 100 (e.g., servers, caches, etc.—not shown in FIG. 1), which may send (e.g., route, forward, etc.) the request to the content server 108. The request may comprise any suitable message for requesting the content, such as a request for a segment of the content, a chunk of the content, a manifest (or portion thereof) for the content, a combination thereof, and/or the like.

The content server 108 may receive the request. Based on the request, the content server 108 may determine whether the content is available locally. For example, the content server 108 may determine whether the corresponding segment, chunk, and/or manifest for the content is available at a cache(s) of the content server 108 or at a storage repository readily accessible by the content server 108 (e.g., within a same network, a same server group, etc.). The content server 108 may determine, at a first time (t₀), that the content requested by the user device 112 is not locally available. Such a scenario may be referred to herein as a “cache miss.” When the content server 108 determines the cache miss (e.g., determines the unavailability of the content locally), the content server 108 may request and/or retrieve the content from another device/component of the system 100. The content server 108 may determine which server, cache, or storage repository of the system 100 has the content available based on caching records, caching rules, caching schedules, load balancing rules, content delivery rules, a combination thereof, and/or the like. For example, the content server 108 may determine that the content is available—or the content server 108 may simply inquire whether the content is available—at the content server 109.

At step 204A, the content server 108 may request and/or retrieve the content from the content server 109. For example, the content server 108 may request and/or retrieve the corresponding segment, chunk, and/or manifest (or portion thereof) for the content from the content server 109. The content server 108 may send a request for the content to the content server 109 directly or via one or more intermediary devices/components of the system 100 (e.g., servers, caches, etc.—not shown in FIG. 1), which may send (e.g., route, forward, etc.) the request to the content server 109. The content server 109 may be upstream with respect to the content server 108 and/or the user device 112. For example, the content server 109 may be “closer” in terms of network hops to an origin/source of the content, or the content server 109 may itself be the origin/source of the content.

At step 206A, the content server 109 may send the content to the content server 108. For example, the content server 109 may send the corresponding segment, chunk, and/or manifest (or portion thereof) for the content to the content server 108. The content server 108 may receive the content from the content server 109 at a second time (t₁).

The content server 108 may determine and/or store an indication of the first time (t₀) and an indication of the second time (t₁) as time stamps, time codes, or by any other suitable method. An amount of time between t₀ and t₁ may represent a processing delay associated with processing the request initially sent by the user device 112 to the content server 108. The amount of time associated with the processing delay may comprise a difference between the first time (t₀), when the content server 108 determines that the content requested by the user device 112 is not locally available, and the second time (t₁), when the content server 108 receives the content from the content server 109. That is, the processing delay (d) may comprise t₁ minus t₀.

The content server 108 may determine at least one delay parameter based on the processing delay. The at least one delay parameter may comprise, or be indicative of, the processing delay (d). For example, the at least one delay parameter may comprise timestamps, timecodes, etc., indicating the first time (t₀) and the second time (t₁). Additionally, or in the alternative, the at least one delay parameter may comprise an amount of time representing the processing delay (d) (e.g., the amount of time between the first time and the second time).

At step 208A, the content server 108 may send an indication of the at least one delay parameter to the user device 112. The content server 108 may send the indication of the at least one delay parameter before, with, or after sending the content itself. The content server 108 may send the indication of the at least one delay parameter via one or more network messages and/or network signaling. For example, the at least one delay parameter may be sent as one or more messages and/or signaling according to any suitable protocol or standard for communicating data/information associated with content delivery, such as the common media server data (CMSD) protocol, the common media client data (CMCD) protocol, the server and network assisted dynamic adaptive streaming over HTTP (SAND) protocol, a combination thereof, and/or the like. Other examples are possible as well, such as metadata appended to the content that indicates the at least one delay parameter, a message(s) sent using a networking protocol(s) that indicates the at least one delay parameter, signaling associated with the content that indicates the at least one delay parameter, a combination thereof, and/or the like. As further discussed herein, the user device 112 may determine a service metric based on the at least one delay parameter.

FIG. 2B shows another example workflow 200B for content delivery. The workflow 200B may be implemented by the system 100 as part of the workflow 200A or it may be implemented separately. For example, the workflow 200B may be implemented by the system 100 when requested content is not immediately provided to a requesting device/component (e.g., a client/user device) due to a prioritization scheme of the system 100. The system 100 may process requests for content according to the prioritization scheme to achieve desired network load balancing, in response to limited network resources, a combination thereof, and/or the like.

At step 202B, the user device 112 may send a request for content. The user device 112 may send the request to the content server 108 directly. Additionally, or in the alternative, the request may be sent from the user device 112 to one or more intermediary devices/components of the system 100 (e.g., servers, caches, etc.—not shown in FIG. 1), which may send (e.g., route, forward, etc.) the request to the content server 108. The request may comprise any suitable message for requesting the content, such as a request for a segment of the content, a chunk of the content, a manifest (or portion thereof) for the content, a combination thereof, and/or the like.

The content server 108 may receive the request. At step 204B, the content server 108 may determine a processing delay associated with the request. The content server 108 may determine the processing delay based on the prioritization scheme. For example, the prioritization scheme may comprise a first-in-first-out scheme whereby requests for content are processed in the order in which they are received, and the request sent by the user device 112 may be placed in a queue of requests.

Additionally, or in the alternative, the prioritization scheme may account for an urgency associated with and/or indicated by requests for content. For example, the user device 112 may comprise a playback buffer for storing content that is to be output (e.g., played, displayed, etc.) at a later time, and the request sent by the user device 112 may comprise an indication of a status of the playback buffer. The status of the playback buffer may comprise and/or indicate a buffer starvation and/or a buffer length parameter. The buffer length parameter may represent and/or indicate a size of content stored in the buffer (e.g., memory size) and/or a length of content stored in the buffer (e.g., an amount of time). The prioritization scheme may be implemented by the system 100 to prevent the buffer becoming depleted and causing a stall in content output. For example, the user device 112 may encounter a stall when a next portion(s) of content being output is not received in a timely manner (e.g., prior to content in the buffer being output).

The content server 108 may determine a buffer starvation time based on the status of the playback buffer. The content server 108 may determine the buffer starvation time based on the buffer length parameter. The buffer starvation time may comprise an amount of time that the user device 112 may output one or more portions of the content that are presently stored in the playback buffer (e.g., an amount of time until the playback buffer becomes depleted).

The content server 108 may determine a processing priority for the request. For example, the content server 108 may determine that the request received by the user device 112 at step 202B is to be processed after another request sent by the user device 113. The other request sent by the user device 113 (not shown in FIG. 2B) may have been received by the content server 108 after the request sent by the user device 112 at step 202B. However, the other request sent by the user device 113 may have comprised a status of a playback buffer of the user device 113, such as a corresponding buffer length parameter, that indicates a buffer starvation time for the user device 113 that is smaller (e.g., earlier in time) than the buffer starvation time for the user device 112. The prioritization scheme may cause the content server 108 to prioritize the request sent by the user device 113 over the request sent by the user device 112. For example, the content server 108 may cause the processing priority associated with the user device 113 to be flagged as more urgent, placed ahead in the queue, etc., such that the request sent by the user device 113 will be processed before the request sent by the user device 112 is processed. It is to be understood that the prioritization scheme may cause the content server 108 (and/or the content server 109) to prioritize one request over another for other reasons as well, such as content type, content popularity, device type, device class, service/subscriber type or level, a combination thereof, and/or the like.

The content server 108 may determine a processing delay associated with the request sent by the user device 112 at step 202B. The content server 108 may determine the processing delay based on the processing priority. The processing delay may represent an amount of time between a first time (t₀), when the content server 108 receives the request from the user device 112, and a second time (t₁), when the content server 108 begins processing the request. The content server 108 may determine and/or store an indication of the first time (t₀) and an indication of the second time (t₁) as time stamps, time codes, or by any other suitable method. An amount of time between t₀ and t₁ may represent the processing delay associated with processing the request sent by the user device 112. That is, the processing delay (d) may comprise t₁ minus t₀. Continuing with the example above, the processing delay (d) may represent an amount of time for the content server 108 to process the request sent by the user device 113 and/or any other request that may be queued ahead of the request sent at step 202B by the user device 112 (e.g., based on processing priority).

The content server 108 may determine at least one delay parameter based on the processing delay. The at least one delay parameter may comprise, or be indicative of, the processing delay (d). For example, the at least one delay parameter may comprise timestamps, timecodes, etc., indicating the first time (t₀) and the second time (t₁). Additionally, or in the alternative, the at least one delay parameter may comprise an amount of time representing the processing delay (d) (e.g., the amount of time between the first time and the second time).

At step 206B, the content server 108 may send an indication of the at least one delay parameter to the user device 112. The content server 108 may send the indication of the at least one delay parameter before, with, or after sending the content itself. The content server 108 may send the indication of the at least one delay parameter via one or more network messages and/or network signaling as discussed herein. Other examples are possible as well, such as metadata appended to the content that indicates the at least one delay parameter, a message(s) sent using a networking protocol(s) associated with the content that indicates the at least one delay parameter, signaling associated with the content that indicates the at least one delay parameter, a combination thereof, and/or the like. As further discussed herein, the user device 112 may determine a service metric based on the at least one delay parameter.

FIG. 2C shows another example workflow 200C for content delivery. The workflow 200C may be implemented by the system 100 when a processing delay(s) related to requested content is encountered by the system 100. For example, the workflow 200C may be implemented by content server 108 and/or the content server 109. For purposes of explanation, the workflow 200C is described as being performed by the content server 108. The content server 108 may receive a plurality of content requests from client/user devices. The workflow 200C is described herein as the content server 208 receiving two content requests, however, it is to be understood that the workflow 200C may be equally applicable to more than two content requests.

At step 202C, the user device 112 may send a first request for content. The user device 112 may send the first request to the content server 108 directly. Additionally, or in the alternative, the first request may be sent from the user device 112 to one or more intermediary devices/components of the system 100 (e.g., servers, caches, etc.—not shown in FIG. 1), which may send (e.g., route, forward, etc.) the first request to the content server 108. The first request may comprise any suitable message for requesting the content, such as a request for a segment of the content, a chunk of the content, a manifest (or portion thereof) for the content, a combination thereof, and/or the like. The content server 108 may receive the first request from the user device 112 or an intermediary device of the system 100.

At step 204C, the user device 113 may send a second request for content. The content requested by the user device 112 may, or may not, be the same content requested by the user device 113. The user device 113 may send the second request to the content server 108 directly. Additionally, or in the alternative, the second request may be sent from the user device 113 to one or more intermediary devices/components of the system 100 (e.g., servers, caches, etc.—not shown in FIG. 1), which may send (e.g., route, forward, etc.) the second request to the content server 108. The second request may comprise any suitable message for requesting the content, such as a request for a segment of the content, a chunk of the content, a manifest (or portion thereof) for the content, a combination thereof, and/or the like. The content server 108 may receive the second request from the user device 113 or an intermediary device of the system 100.

The content server 108 may determine a first processing delay (d₁) associated with the first request. The content server 108 may determine a second processing delay (d₂) associated with the second request. Each of the processing delays may be related to a cache miss as described herein with respect to FIG. 2A. Additionally, or in the alternative, each of the processing delays may be related to a prioritization scheme as described herein with respect to FIG. 2B.

The first processing delay (d₁) may be associated with timestamps, timecodes, etc., indicating a beginning time for the first processing delay (t₀) and an ending time for the first processing delay (t₁). Additionally, or in the alternative, the first processing delay (d₁) may be associated with an amount of time representing the first processing delay (d₁) (e.g., an amount of time between t₀ and t₁). The second processing delay (d₂) may be associated with timestamps, timecodes, etc., indicating a beginning time for the second processing delay (t′₀) and an ending time for the second processing delay (t′₁). Additionally, or in the alternative, the processing delay (d₂) may be associated with an amount of time representing the second processing delay (d₂) (e.g., an amount of time between t′₀ and t′₁).

The content server 108 may determine whether the first processing delay (d₁) and/or the second processing delay (d₂) meet or exceed a delay threshold. The delay threshold may comprise an amount of time in any suitable unit (e.g., seconds, milliseconds, etc.). The delay threshold may represent an acceptable length of time for a processing delay associated with requested content. As further described herein, the user devices 112 and 113 may each determine at least one service metric related to requested content. The at least one service metric may be a quality of service measurement, a quality of experience measurement, a bandwidth measurement, a combination thereof, and/or the like. The user device 112 and/or 113 may each determine at least one service metric according to adaptation logic to make rate adaptation decisions, such as determining whether to request an alternative representation of requested content (e.g., a differing resolution and/or bitrate).

The content server 108 may indicate the first processing delay and the second processing delay to the user devices 112 and 113, respectively, when the associated processing delay meets or exceeds the delay threshold. However, the content server 108 may not indicate the first processing delay and/or the second processing delay to the user devices 112 and 113, respectively, when the associated processing delay does not meet or exceed the delay threshold. For example, if the first processing delay (d₁) was due to a cache miss and/or a processing priority that is negligible and/or temporary, then the first processing delay (d₁) may not meet or exceed the delay threshold, and the content server 108 may accordingly not indicate the first processing delay (d₁) to the user device 112. The amount of time of the delay threshold may be set (or adjusted) to account for such a scenario, as well as other scenarios, where the corresponding processing delay is temporary, negligible, or otherwise not expected to impact request processing and content delivery.

The delay threshold may be set, determined, indicated, adjusted, etc., by the system 100 based on a variety of conditions, configurations, rules, etc., such as content type, content popularity, device type, device class, service/subscriber type or level, a combination thereof, and/or the like. For example, the delay threshold may be based on a device type associated with the user device 112 and/or the user device 113 (e.g., to account for varying playback buffer sizes between device types). The delay threshold may be set by the system 100 based on network conditions (e.g., lower or higher amount of time based on bandwidth availability). The delay threshold may be set by the system 100 based on content type (e.g., to account for encoding/decoding time, transmission/sending time, etc.). Additionally, or in the alternative, the delay threshold may be set, determined, indicated, adjusted, etc., by the user device 112 and/or the user device 113 and communicated to the content server 108 and/or the content server 109 as part of a request for content and/or a message(s)/signaling sent to the content server 108 and/or the content server 109 (e.g., a message(s) or signaling comprising a common media client data (CMCD) parameter(s)). Other examples are possible as well.

The content server 108 may determine at least one delay parameter based on the first processing delay (referred to herein as a “first delay parameter”) when the first processing delay (di) meets or exceeds the delay threshold. The content server 108 may determine at least one delay parameter based on the second processing delay (referred to herein as a “second delay parameter”) when the second processing delay (d₂) meets or exceeds the delay threshold. The first delay parameter may comprise, or be indicative of, the first processing delay (di). For example, the first delay parameter may comprise timestamps, timecodes, etc., indicating a beginning time for the first processing delay (t₀) and an ending time for the first processing delay (t₁). Additionally, or in the alternative, the first delay parameter may comprise an amount of time representing the first processing delay (d₁) (e.g., an amount of time between t₀ and t₁). The second delay parameter may comprise, or be indicative of, the second processing delay (d₂). For example, the second delay parameter may comprise timestamps, timecodes, etc., indicating a beginning time for the second processing delay (t′₀) and an ending time for the second processing delay (t′₁). Additionally, or in the alternative, the second delay parameter may comprise an amount of time representing the second processing delay (d₂) (e.g., an amount of time between t′₀ and t′₁).

At step 206C, the content server 108 may send an indication of the second delay parameter to the user device 113 when the second processing delay (d₂) meets or exceeds the delay threshold. At step 208C, the content server 108 may send an indication of the first delay parameter to the user device 112 when the first processing delay (d₁) meets or exceeds the delay threshold. Steps 206C and 208C may be performed simultaneously/concurrently or in reverse order. For example, the content server 108 may send the indication of the first delay parameter to the user device 112 at substantially the same time, or before, the content server 108 sends the indication of the second delay parameter to the user device 113. As another example, the content server 108 may send the indication of the second delay parameter to the user device 113 at substantially the same time, or before, the content server 108 sends the indication of the first delay parameter to the user device 112. The content server 108 may send the indication of the first delay parameter and/or the second delay parameter before, with, or after sending the content itself to the respective user device 112 or 113. For example, the content server 108 may send the indication of the first delay parameter to the user device 112 at any of the following times: before the content server 108 sends the requested content to the user device 112; at the same time the content server 108 sends the requested content to the user device 112; or after the content server 108 sends the requested content to the user device 112. As another example, the content server 108 may send the indication of the second delay parameter to the user device 113 at any of the following times: before the content server 108 sends the requested content to the user device 113; at the same time the content server 108 sends the requested content to the user device 113; or after the content server 108 sends the requested content to the user device 113. The content server 108 may send the indication of the first delay parameter and/or the second delay parameter via one or more messages and/or network signaling, such as a CMSD parameter/message as discussed herein. Other examples are possible as well, such as metadata appended to the content that indicates the corresponding delay parameter, a message(s) sent using a protocol(s) associated with the content that indicates the delay parameter, signaling associated with the content that indicates the delay parameter, a combination thereof, and/or the like.

As described herein, the user device 112 and/or 113 may each determine at least one service metric according to adaptation logic to make rate adaptation decisions, such as determining whether to request an alternative representation of requested content (e.g., a differing resolution and/or bitrate). The at least one service metric may comprise or be indicative of: an estimated amount of time for receiving further portions of the content, a rate adaptation metric, a buffer starvation time, a quality of service metric, a quality of experience metric, etc.

The at least one service metric may relate to (e.g., it may comprise or be indicative of) of a throughput measurement for requested content. The user device 112 and/or 113 may determine a throughput measurement for a portion(s) of requested content based on a size “S” of the portion(s) of requested content that is received divided by an amount of time associated with receiving the content, which may be represented as a request time (r₀) and a time the requested content is received (r₁): S/(r₁-r₀). However, this formula may not account for corresponding processing delay(s), which may result in the user device 112/113 making an inaccurate/unnecessary rate adaptation decision, such as switching representations when network conditions do not necessitate it.

As described herein, the content server 108 and/or 109 may indicate at least one delay parameter to the user device 112/113 when requested content is delivered. The content server 108 and/or 109 may indicate a type of delay (e.g., cache miss, prioritization delay, etc.) when the at least one delay parameter is sent and/or indicated to the user device 112/113. The at least one delay parameter may indicate or comprise a processing delay (t₀), a beginning time for the corresponding processing delay (t₀), and/or an ending time for the corresponding processing delay (t₁). The throughput measurement may be determined by the corresponding user device 112 or 113 based on the at least one delay parameter as S/(r₁−r₀−(t₁−t₀)). The at least one delay parameter may therefore enable the corresponding user device 112 or 113 to determine the at least one service metric more accurately (e.g., to account for the processing delay, to disregard the processing delay, etc.). As a result, the corresponding user device 112 or 113 may be enabled to make better rate adaptation decisions that reflect network conditions more accurately.

FIG. 2D shows an example workflow 200D for content delivery and rate adaptation decision making. The workflow 200D may be implemented by the system 100 when a processing delay(s) related to requested content is encountered by the system 100. For example, the workflow 200D may be implemented by user device 112 and/or 113. For purposes of explanation, the workflow 200C is described as being performed by the user device 112 when making rate adaptation decisions.

At step 202D, the user device 112 may send a first request for content. The user device 112 may send the first request to the content server 108 directly. Additionally, or in the alternative, the first request may be sent from the user device 112 to one or more intermediary devices/components of the system 100 (e.g., servers, caches, etc.—not shown in FIG. 1), which may send (e.g., route, forward, etc.) the first request to the content server 108. The first request may comprise any suitable message for requesting the content, such as a request for a segment of the content, a chunk of the content, a manifest (or portion thereof) for the content, a combination thereof, and/or the like.

The content server 108 may receive the first request from the user device 112 or an intermediary device of the system 100. The content server 108 may determine at least one delay parameter based on a processing delay (d) associated with the first request. The processing delay (d) may be related to a cache miss or a prioritization delay as described herein. The at least one delay parameter may comprise, or be indicative of, the processing delay (d). For example, the at least one delay parameter may comprise timestamps, timecodes, etc., indicating a beginning time of the processing delay (t₀) and an ending time of the processing delay (t₁). Additionally, or in the alternative, the at least one delay parameter may comprise an amount of time representing the processing delay (d) (e.g., the amount of time between the beginning time and the ending time).

At step 204D, the content server 108 may send an indication of the at least one delay parameter to the user device 112. The content server 108 may send the indication of the at least one delay parameter before, with, or after sending the requested content itself. The content server 108 may send the indication of the at least one delay parameter via one or more messages and/or network signaling, such as a CMSD parameter/message as discussed herein. Other examples are possible as well, such as metadata appended to the content that indicates the at least one delay parameter, a message(s) sent using a protocol(s) associated with the content that indicates the at least one delay parameter, signaling associated with the content that indicates the at least one delay parameter, a combination thereof, and/or the like.

The user device 112 may determine a service metric based on the at least one delay parameter. The service metric, as described herein, may comprise a throughput measurement related to the requested content. The user device 112 may make one or more rate adaptation decisions based on the service metric. At step 206D, the user device 112 may request a further portion(s) of the content from the content server 109 based on the service metric. For example, the service metric—and by extension the at least one delay parameter/the processing delay—may lead to a rate adaptation decision(s) that causes the user device 112 to request the further portion(s) of the content from the content server 109 rather than the content server 108. Additionally, or in the alternative, at step 208D the user device 112 may request a further portion(s) of the content at a different representation (e.g., a lower or higher quality level/bitrate) based on the service metric. For example, the service metric—and by extension the at least one delay parameter/the processing delay—may lead to a rate adaptation decision(s) that causes the user device 112 to request the further portion(s) of the content at the different representation as opposed the representation requested at step 202D. Though FIG. 2D indicates the user device 112 requests the further portions) of the content from the content server 108, it is to be understood that the user device 112 may request the further portion(s) of the content from the content server 109 as well or in the alternative.

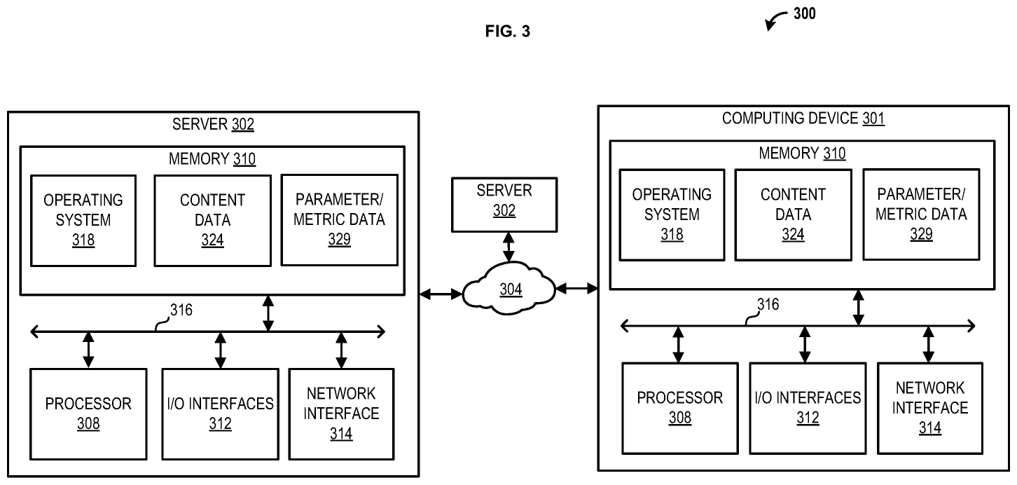

The present methods and systems may be computer-implemented. FIG. 3 shows a block diagram depicting a system/environment 300 comprising non-limiting examples of a computing device 301 and a server 302 connected through a network 304. Either of the computing device 301 or the server 302 may be a computing device, such as any of the devices of the system 100 shown in FIG. 1. In an aspect, some or all steps of any described method may be performed on a computing device as described herein. The computing device 301 may comprise one or multiple computers configured to store parameter/metric data 329 (e.g., relating to processing parameters, delay parameters, metrics, delay parameters, etc.), and/or the like. The server 302 may comprise one or multiple computers configured to store content data 324 (e.g., a plurality of content segments, parameters, etc.). Multiple servers 302 may communicate with the computing device 301 via the through the network 304.

The computing device 301 and the server 302 may be a digital computer that, in terms of hardware architecture, generally includes a processor 308, system memory 310, input/output (I/O) interfaces 312, and network interfaces 314. These components (308, 310, 312, and 314) are communicatively coupled via a local interface 316. The local interface 316 may be, for example, but not limited to, one or more buses or other wired or wireless connections, as is known in the art. The local interface 316 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 308 may be a hardware device for executing software, particularly that stored in system memory 310. The processor 308 may be any custom made or commercially available processor, a central processing unit (CPU), an auxiliary processor among several processors associated with the computing device 301 and the server 302, a semiconductor-based microprocessor (in the form of a microchip or chip set), or generally any device for executing software instructions. When the computing device 301 and/or the server 302 is in operation, the processor 308 may execute software stored within the system memory 310, to communicate data to and from the system memory 310, and to generally control operations of the computing device 301 and the server 302 pursuant to the software.

The I/O interfaces 312 may be used to receive user input from, and/or for providing system output to, one or more devices or components. User input may be provided via, for example, a keyboard and/or a mouse. System output may be provided via a display device and a printer (not shown). I/O interfaces 312 may include, for example, a serial port, a parallel port, a Small Computer System Interface (SCSI), an infrared (IR) interface, a radio frequency (RF) interface, and/or a universal serial bus (USB) interface.

The network interface 314 may be used to transmit and receive from the computing device 301 and/or the server 302 on the network 304. The network interface 314 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 314 may include address, control, and/or data connections to enable appropriate communications on the network 304.

The system memory 310 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 310 may incorporate electronic, magnetic, optical, and/or other types of storage media. Note that the system memory 310 may have a distributed architecture, where various components are situated remote from one another, but may be accessed by the processor 308.

The software in system memory 310 may include one or more software programs, each of which comprises an ordered listing of executable instructions for implementing logical functions. In the example of FIG. 3, the software in the system memory 310 of the computing device 301 may comprise the parameter/metric data 329, the content data 324, and a suitable operating system (O/S) 318. In the example of FIG. 3, the software in the system memory 310 of the server 302 may comprise the parameter/metric data 329, the content data 324, and a suitable operating system (O/S) 318. The operating system 318 essentially controls the execution of other computer programs and provides scheduling, input-output control, file and data management, memory management, and communication control and related services.

For purposes of illustration, application programs and other executable program components such as the operating system 318 are shown herein as discrete blocks, although it is recognized that such programs and components may reside at various times in different storage components of the computing device 301 and/or the server 302. An implementation of the system/environment 300 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

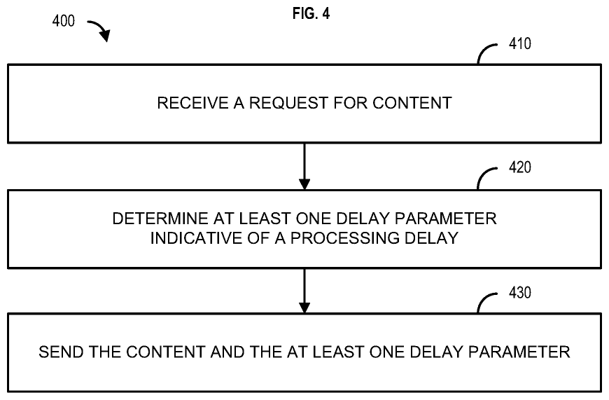

FIG. 4 shows a flowchart of an example method 400 for signaling server-associated delays in content delivery. The method 400 may be performed in whole or in part by a single computing device, a plurality of computing devices, and the like. For example, the steps of the method 400 may be performed by the content server 108, the content server 109, and/or a computing device in communication with the content server 108 or the content server 109. Some steps of the method 400 may be performed by a first computing device (e.g., the content server 108), while other steps of the method 400 may be performed by another computing device.

At step 410, the first computing device may receive a request for content. For example, a second computing device, such as the user device 112, may send the request for content to the first computing device. The second computing device may send the request to the first computing device directly. Additionally, or in the alternative, the request may be sent from the second computing device to one or more intermediary devices/components in communication with the c. The request may comprise any suitable message for requesting the content, such as a request for a segment of the content, a chunk of the content, a manifest (or portion thereof) for the content, a combination thereof, and/or the like.

The first computing device may receive the request. Based on the request, the first computing device may determine whether the content is available locally. For example, the first computing device may determine whether the corresponding segment, chunk, and/or manifest for the content is available at a cache(s) of the first computing device or at a storage repository readily accessible by the first computing device (e.g., within a same network, a same server group, etc.). The first computing device may determine, at a first time (t₀), that the content requested by the second computing device is not locally available. Such a scenario may be referred to herein as a “cache miss.” When the first computing device determines the cache miss (e.g., determines the unavailability of the content locally), the first computing device may request and/or retrieve the content from another device/component. The first computing device may determine which server, cache, or storage repository has the content available based on caching records, caching rules, caching schedules, load balancing rules, content delivery rules, a combination thereof, and/or the like. For example, the first computing device may determine that the content is available—or the first computing device may simply inquire whether the content is available—at a third computing device, such as the content server 109.

The first computing device may request and/or retrieve the content from the third computing device. For example, the first computing device may request and/or retrieve the corresponding segment, chunk, and/or manifest (or portion thereof) for the content from the third computing device. The first computing device may send a request for the content to the third computing device directly or via one or more intermediary devices/components (e.g., servers, caches, etc.), which may send (e.g., route, forward, etc.) the request to the third computing device. The third computing device may be upstream with respect to the first computing device and/or the second computing device. For example, the third computing device may be “closer” in terms of network hops to an origin/source of the content, or the third computing device may itself be the origin/source of the content.

The third computing device may send the content to the first computing device. For example, the third computing device may send the corresponding segment, chunk, and/or manifest (or portion thereof) for the content to the first computing device. The first computing device may receive the content from the third computing device at a second time (t₁).

The first computing device may determine and/or store an indication of the first time (t₀) and an indication of the second time (t₁) as time stamps, time codes, or by any other suitable method. An amount of time between t₀ and t₁ may represent a processing delay associated with processing the request initially sent by the second computing device to the first computing device. The amount of time associated with the processing delay may comprise a difference between the first time (t₀), when the first computing device determines that the content requested by the second computing device is not locally available, and the second time (t₁), when the first computing device receives the content from the third computing device. That is, the processing delay (d) may comprise t₁ minus t₀.

In some examples, the processing delay may be based on, or a result of, a prioritization scheme. For example, the prioritization scheme may comprise a first-in-first-out scheme whereby requests for content are processed in the order in which they are received, and the request sent by the second computing device may be placed in a queue of requests. Additionally, or in the alternative, the prioritization scheme may account for an urgency associated with and/or indicated by requests for content. For example, the second computing device may comprise a playback buffer for storing content that is to be output (e.g., played, displayed, etc.) at a later time, and the request sent by the second computing device may comprise an indication of a status of the playback buffer. The status of the playback buffer may comprise and/or indicate a buffer starvation and/or a buffer length parameter. The buffer length parameter may represent and/or indicate a size of content stored in the buffer (e.g., memory size) and/or a length of content stored in the buffer (e.g., an amount of time).

The first computing device may determine a buffer starvation time based on the status of the playback buffer. The first computing device may determine the buffer starvation time based on the buffer length parameter. The buffer starvation time may comprise an amount of time that the second computing device may output one or more portions of the content that are presently stored in the playback buffer (e.g., an amount of time until the playback buffer becomes depleted).

The first computing device may determine a processing priority for the request. For example, the first computing device may determine that the request received by the second computing device is to be processed after a request sent by a fourth computing device (e.g., an additional user device). The request sent by the fourth computing device may have been received by the first computing device after the request sent by the second computing device was received. However, the request sent by the fourth computing device may have comprised a status of a playback buffer of the fourth computing device, such as a corresponding buffer length parameter, that indicates a buffer starvation time for the fourth computing device that is smaller (e.g., earlier in time) than the buffer starvation time for the second computing device. The prioritization scheme may cause the first computing device to prioritize the request sent by the fourth computing device over the request sent by the second computing device. For example, the first computing device may cause the processing priority associated with the fourth computing device to be flagged as more urgent, placed ahead in the queue, etc., such that the request sent by the fourth computing device will be processed before the request sent by the second computing device is processed.

The first computing device may determine the processing delay based on the processing priority. The processing delay may represent an amount of time between the first computing device receiving the request from the second computing device and the first computing device processing the request. The first computing device may determine and/or store an indication of the processing delay as time stamps, time codes, or by any other suitable method. Continuing with the example above, the processing delay may represent an amount of time for the first computing device to process the request sent by the fourth computing device and/or any other request that may be queued ahead of the request sent by the second device (e.g., based on processing priority).

At step 420, the first computing device may determine at least one delay parameter based on the processing delay. The at least one delay parameter may comprise, or be indicative of, the processing delay (d). For example, the at least one delay parameter may comprise timestamps, timecodes, etc., indicating the first time (t₀) and the second time (t₁). Additionally, or in the alternative, the at least one delay parameter may comprise an amount of time representing the processing delay (d) (e.g., the amount of time between the first time and the second time). The first computing device may determine the at least one delay parameter based on the processing delay described herein, if applicable.

At step 430, the first computing device may send the content and an indication of the at least one delay parameter to the second computing device. The first computing device may send the indication of the at least one delay parameter before, with, or after sending the content itself. The first computing device may send the indication of the at least one delay parameter via one or more messages and/or network signaling, such as a CMSD parameter/message as discussed herein. Other examples are possible as well, such as metadata appended to the content that indicates the at least one delay parameter, a message(s) sent using a protocol(s) associated with the content that indicates the at least one delay parameter, signaling associated with the content that indicates the at least one delay parameter, a combination thereof, and/or the like.

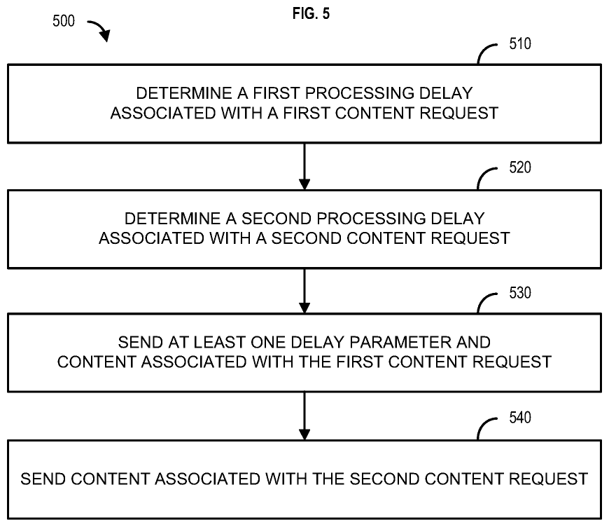

FIG. 5 shows a flowchart of an example method 500 for signaling server-associated delays in content delivery. The method 500 may be performed in whole or in part by a single computing device, a plurality of computing devices, and the like. For example, the steps of the method 500 may be performed by the content server 108, the content server 109, and/or a computing device in communication with the content server 108 or the content server 109.

Some steps of the method 500 may be performed by a first computing device (e.g., the content server 108), while other steps of the method 500 may be performed by another computing device.

The first computing device may receive a plurality of content requests from a plurality of computing devices (e.g., client/user devices). The method 500 is described herein as the first computing device receiving two content requests, however, it is to be understood that the method 500 may be equally applicable to more than two content requests.

A second computing device, such as the user device 112, may send a first request for content. The second computing device may send the first request to the first computing device directly. Additionally, or in the alternative, the first request may be sent from the second computing device to one or more intermediary devices/components, which may send (e.g., route, forward, etc.) the first request to the first computing device. The first request may comprise any suitable message for requesting the content, such as a request for a segment of the content, a chunk of the content, a manifest (or portion thereof) for the content, a combination thereof, and/or the like. The first computing device may receive the first request from the second computing device or an intermediary device.

A third computing device, such as the user device 113, may send a second request for content. The content requested by the second computing device may, or may not, be the same content requested by the third computing device. The third computing device may send the second request to the first computing device directly. Additionally, or in the alternative, the second request may be sent from the third computing device to one or more intermediary devices/components, which may send (e.g., route, forward, etc.) the second request to the first computing device. The second request may comprise any suitable message for requesting the content, such as a request for a segment of the content, a chunk of the content, a manifest (or portion thereof) for the content, a combination thereof, and/or the like. The first computing device may receive the second request from the third computing device or an intermediary device.

At step 510, the first computing device may determine a first processing delay (d₁) associated with the first request. The first processing delay (d₁) may be associated with timestamps, timecodes, etc., indicating a beginning time for the first processing delay (t₀) and an ending time for the first processing delay (t₁). Additionally, or in the alternative, the first processing delay (d₁) may be associated with an amount of time representing the first processing delay (d₁) (e.g., an amount of time between t₀ and t₁). At step 520, the first computing device may determine a second processing delay (d₂) associated with the second request. The second processing delay (d₂) may be associated with timestamps, timecodes, etc., indicating a beginning time for the second processing delay (t′₀ ) and an ending time for the second processing delay (t′₁). Additionally, or in the alternative, the processing delay (d₂) may be associated with an amount of time representing the second processing delay (d₂) (e.g., an amount of time between t′₀ and t′₁). Each of the processing delays may be related to a cache miss as described herein with respect to FIG. 2A. Additionally, or in the alternative, each of the processing delays may be related to a prioritization scheme as described herein with respect to FIG. 2B.

The first computing device may determine whether the first processing delay (d₁) and/or the second processing delay (d₂) meet or exceed a delay threshold. The delay threshold may comprise an amount of time in any suitable unit (e.g., seconds, milliseconds, etc.). The delay threshold may represent an acceptable length of time for a processing delay associated with requested content. As described herein, the second and third computing devices may each determine at least one service metric related to requested content. The at least one service metric may be a quality of service measurement, a quality of experience measurement, a bandwidth measurement, a combination thereof, and/or the like. The second computing device and/or the third computing device may each determine at least one service metric according to adaptation logic to make rate adaptation decisions, such as determining whether to request an alternative representation of requested content (e.g., a differing resolution and/or bitrate).

The first computing device may indicate the first processing delay and the second processing delay to the second and third computing devices, respectively, when the associated processing delay meets or exceeds the delay threshold. However, the first computing device may not indicate the first processing delay and/or the second processing delay when the associated processing delay does not meet or exceed the delay threshold. For example, if the first processing delay (d₁) was due to a cache miss or a processing priority that is negligible and/or temporary, then the first processing delay (d₁) may not meet or exceed the delay threshold, and the first computing device may accordingly not indicate the first processing delay (d₁) to the second computing device.

The first computing device may determine at least one delay parameter based on the first processing delay (referred to herein as a “first delay parameter”) when the first processing delay (d₁) meets or exceeds the delay threshold. The first computing device may determine at least one delay parameter based on the second processing delay (referred to herein as a “second delay parameter”) when the second processing delay (d₂) meets or exceeds the delay threshold. The first delay parameter may comprise, or be indicative of, the first processing delay (d₁). For example, the first delay parameter may comprise timestamps, timecodes, etc., indicating a beginning time for the first processing delay (t₀) and an ending time for the first processing delay (t₁). Additionally, or in the alternative, the first delay parameter may comprise an amount of time representing the first processing delay (d₁) (e.g., an amount of time between t₀ and t₁). The second delay parameter may comprise, or be indicative of, the second processing delay (d₂). For example, the second delay parameter may comprise timestamps, timecodes, etc., indicating a beginning time for the second processing delay (t′₀) and an ending time for the second processing delay (t′₁). Additionally, or in the alternative, the second delay parameter may comprise an amount of time representing the second processing delay (d₂) (e.g., an amount of time between t′₀ and t′₁).

At step 530, the first computing device may send an indication of at least one delay parameter (the first delay parameter) and content associated with the first request to the second computing device. For example, the first computing device may send the indication of at least one delay parameter (the first delay parameter) to the second computing device when the first processing delay (d₁) meets or exceeds the delay threshold. The first computing device may send the indication of the first delay parameter before, with, or after sending the content itself to the second computing device. The first computing device may send the indication of the first delay parameter via one or more messages and/or network signaling, such as a CMSD parameter/message as discussed herein. Other examples are possible as well, such as metadata appended to the content that indicates the corresponding delay parameter, a message(s) sent using a protocol(s) associated with the content that indicates the delay parameter, signaling associated with the content that indicates the delay parameter, a combination thereof, and/or the like.

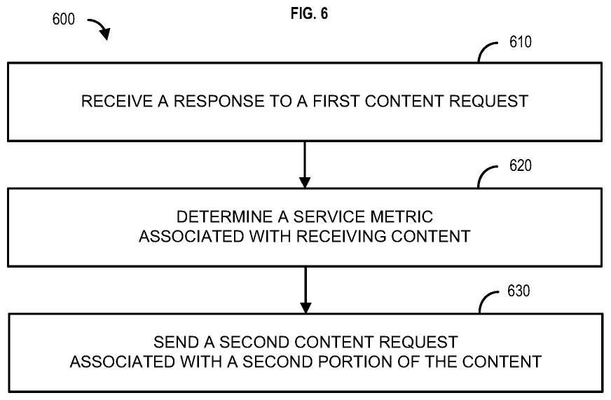

FIG. 6 shows a flowchart of an example method 600 for signaling server-associated delays in content delivery. The method 600 may be performed in whole or in part by a single computing device, a plurality of computing devices, and the like. For example, the steps of the method 600 may be performed by the user device 112, the user device 113, and/or a computing device in communication with the user device 112 and/or the user device 113. Some steps of the method 600 may be performed by a first computing device (e.g., the user device 112), while other steps of the method 600 may be performed by another computing device. The method 600 may be implemented by first computing device when making rate adaptation decisions.

The first computing device may send a first request for content. The first computing device may send the first request to a second computing device (e.g., the content server 108) directly. Additionally, or in the alternative, the first request may be sent from the first computing device to one or more intermediary devices/components, which may send (e.g., route, forward, etc.) the first request to the second computing device. The first request may comprise any suitable message for requesting the content, such as a request for a segment of the content, a chunk of the content, a manifest (or portion thereof) for the content, a combination thereof, and/or the like.

The second computing device may receive the first request from the first computing device or an intermediary device. The second computing device may determine at least one delay parameter based on a processing delay (d) associated with the first request. The processing delay (d) may be related to a cache miss or a prioritization delay as described herein. The at least one delay parameter may comprise, or be indicative of, the processing delay (d). For example, the at least one delay parameter may comprise timestamps, timecodes, etc., indicating a beginning time of the processing delay (t₀) and an ending time of the processing delay (t₁). Additionally, or in the alternative, the at least one delay parameter may comprise an amount of time representing the processing delay (d) (e.g., the amount of time between the beginning time and the ending time).

The second computing device may send an indication of the at least one delay parameter to the first computing device. At step 610, the first computing device may receive a response to the first content request. The response may comprise a portion(s) of the requested content and/or the indication of the at least one delay parameter. The second computing device may send the indication of the at least one delay parameter before, with, or after sending the requested content itself. The second computing device may send the indication of the at least one delay parameter via one or more messages and/or network signaling, such as a CMSD parameter/message as discussed herein. Other examples are possible as well, such as metadata appended to the content that indicates the at least one delay parameter, a message(s) sent using a protocol(s) associated with the content that indicates the at least one delay parameter, signaling associated with the content that indicates the at least one delay parameter, a combination thereof, and/or the like.

At step 620, the first computing device may determine at least one service metric associated with receiving the content. For example, the first computing device may determine the at least one service metric based on the at least one delay parameter (or the indication thereof). The at least one service metric, as described herein, may comprise a throughput measurement related to the requested content. The first computing device determine the at least one service metric according to adaptation logic to make rate adaptation decisions, such as determining whether to request an alternative representation of requested content (e.g., a differing resolution and/or bitrate). The at least one service metric may comprise or be indicative of: an estimated amount of time for receiving further portions of the content, a rate adaptation metric, a buffer starvation time, a quality of service metric, a quality of experience metric, etc. The at least one service metric may relate to (e.g., it may comprise or be indicative of) of a throughput measurement for the requested content. The second computing device may indicate a type of delay (e.g., cache miss, prioritization delay, etc.) when the at least one delay parameter is sent and/or indicated to the first computing device.

The first computing device may make one or more rate adaptation decisions based on the at least one service metric. At step 630, the first computing device may send a second content request associated with a second portion(s) of the content. The first computing device may send the second content request based on the at least one service metric. For example, the service metric—and by extension the at least one delay parameter/the processing delay—may lead to a rate adaptation decision(s) that causes the first computing device to send the second content request to a third computing device (e.g., the content server 109) rather than the second computing device. Additionally, or in the alternative, the first computing device may request a further portion(s) of the content at a different representation (e.g., a lower or higher quality level/bitrate) based on the at least one service metric. For example, the service metric—and by extension the at least one delay parameter/the processing delay—may lead to a rate adaptation decision(s) that causes the first computing device to request the further portion(s) of the content at a different representation.

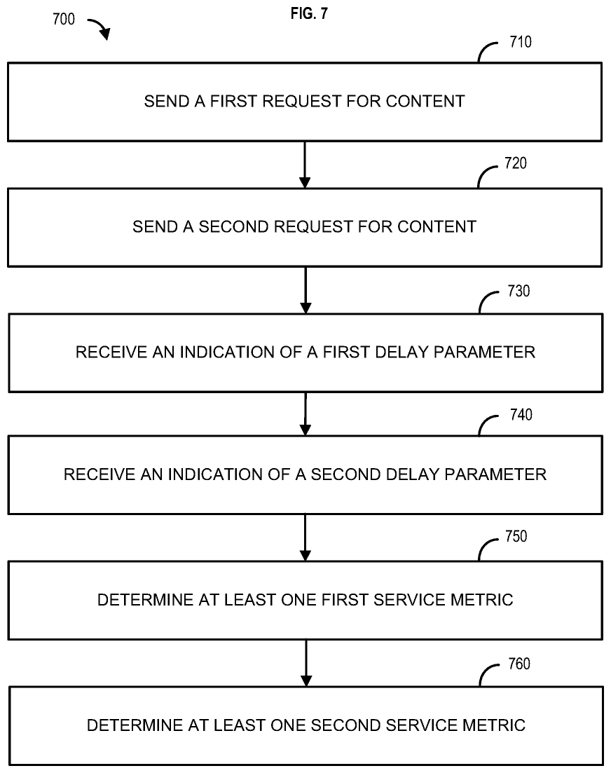

FIG. 7 shows a flowchart of an example method 700 for signaling server-associated delays in content delivery. The method 700 may be performed in whole or in part by one or more of a plurality of computing devices. For example, the steps of the method 700 may be performed by the user device 112, the user device 113, and/or a computing device in communication with the user device 112 and/or the user device 113. Some steps of the method 700 may be performed by a first computing device of a plurality of computing devices (e.g., the user device 112), while other steps of the method 700 may be performed by a second computing device of the plurality of computing devices (e.g., the user device 113).

At step 710, the first computing device, of the plurality of computing devices, may send a first request for content. For example, the first computing device may send the first request to an upstream computing device(s). The upstream computing device(s) may comprise one or more of the content server 108, the content server 109, or a computing device(s) in communication with the content server 108 or the content server 109. The first computing device may send the first request to the upstream computing device(s) directly. Additionally, or in the alternative, the first request may be sent from the first computing device to one or more intermediary devices/components, which may send (e.g., route, forward, etc.) the first request to the upstream computing device(s). The first request may comprise any suitable message for requesting the content, such as a request for a segment of the content, a chunk of the content, a manifest (or portion thereof) for the content, a combination thereof, and/or the like. The upstream computing device(s) may receive the first request from the first computing device or an intermediary device(s).

At step 720, the second computing device, of the plurality of computing devices, may send a second request for content. The content requested by the first computing device may, or may not, be the same content requested by the second computing device. The second computing device may send the second request to the upstream computing device(s) directly. Additionally, or in the alternative, the second request may be sent from the second computing device to one or more intermediary devices/components, which may send (e.g., route, forward, etc.) the second request to the upstream computing device(s). The second request may comprise any suitable message for requesting the content, such as a request for a segment of the content, a chunk of the content, a manifest (or portion thereof) for the content, a combination thereof, and/or the like. The upstream computing device(s) may receive the second request from the second computing device or an intermediary device(s).

The upstream computing device(s) may determine a first processing delay (d₁) associated with the first request. The first processing delay (d₁) may be associated with timestamps, timecodes, etc., indicating a beginning time for the first processing delay (t₀) and an ending time for the first processing delay (t₁). Additionally, or in the alternative, the first processing delay (d₁) may be associated with an amount of time representing the first processing delay (d₁) (e.g., an amount of time between t₀ and t₁). The upstream computing device(s) may determine a second processing delay (d₂) associated with the second request. The second processing delay (d₂) may be associated with timestamps, timecodes, etc., indicating a beginning time for the second processing delay (t′₀) and an ending time for the second processing delay (t′₁). Additionally, or in the alternative, the processing delay (d₂) may be associated with an amount of time representing the second processing delay (d₂) (e.g., an amount of time between t′₀ and t′₁). Each of the processing delays may be related to a cache miss as described herein with respect to FIG. 2A. Additionally, or in the alternative, each of the processing delays may be related to a prioritization scheme as described herein with respect to FIG. 2B.

The upstream computing device(s) may determine whether the first processing delay (d₁) and/or the second processing delay (d₂) meet or exceed a delay threshold. The delay threshold may comprise an amount of time in any suitable unit (e.g., seconds, milliseconds, etc.). The delay threshold may represent an acceptable length of time for processing delays associated with requested content.

The upstream computing device(s) may indicate the first processing delay and the second processing delay to the first and second computing devices, respectively, when the associated processing delay meets or exceeds the delay threshold. However, the upstream computing device(s) may not indicate the first processing delay and/or the second processing delay when the associated processing delay does not meet or exceed the delay threshold. For example, if the first processing delay (d₁) was due to a cache miss or a processing priority associated with the first computing device and/or the first request that is negligible and/or temporary, then the first processing delay (d₁) may not meet or exceed the delay threshold, and the upstream computing device(s) may accordingly not indicate the first processing delay (d₁) to the first computing device. Additionally, or in the alternative, if the second processing delay (d₂) was due to a cache miss or a processing priority associated with the second computing device and/or the second request that is negligible and/or temporary, then the second processing delay (d₂) may not meet or exceed the delay threshold, and the upstream computing device(s) may accordingly not indicate the second processing delay (d₂) to the second computing device.

The upstream computing device(s) may determine at least one first delay parameter based on the first processing delay(d₁) (referred to herein as a “first delay parameter”) when the first processing delay (d₁) meets or exceeds the delay threshold. The first delay parameter may comprise, or be indicative of, the first processing delay (d₁). For example, the first delay parameter may comprise timestamps, timecodes, etc., indicating the beginning time for the first processing delay (t₀) and the ending time for the first processing delay (t₁). Additionally, or in the alternative, the first delay parameter may comprise an amount of time representing the first processing delay (d₁) (e.g., an amount of time between t₀ and t₁).

The upstream computing device(s) may determine at least one second delay parameter based on the second processing delay (d₂) (referred to herein as a “second delay parameter”) when the second processing delay (d₂) meets or exceeds the delay threshold. The second delay parameter may comprise, or be indicative of, the second processing delay (d₂). For example, the second delay parameter may comprise timestamps, timecodes, etc., indicating the beginning time for the second processing delay (t′₀) and the ending time for the second processing delay (t′₁). Additionally, or in the alternative, the second delay parameter may comprise an amount of time representing the second processing delay (d₂) (e.g., an amount of time between t′₀ and t′₁).

At step 730, the first computing device may receive an indication of the first delay parameter (the at least one first delay parameter) and the content (or a portion thereof) associated with the first request. For example, the upstream computing device(s) may send the indication of the first delay parameter and/or the content associated with the first request to the first computing device. The upstream computing device(s) may send the indication of the first delay parameter when the first processing delay (d₁) meets or exceeds the delay threshold. The upstream computing device(s) may send the indication of the first delay parameter before, with, or after sending the content itself to the first computing device. The upstream computing device(s) may send the indication of the first delay parameter via one or more messages and/or network signaling, such as a CMSD parameter/message as discussed herein. Other examples are possible as well, such as metadata appended to the content that indicates the first delay parameter, a message(s) sent using a protocol(s) associated with the content that indicates the first delay parameter, signaling associated with the content that indicates the first delay parameter, a combination thereof, and/or the like.

At step 740, the second computing device may receive an indication of the second delay parameter (the at least one second delay parameter) and the content (or a portion thereof) associated with the second request. For example, the upstream computing device(s) may send the indication of the second delay parameter and/or the content associated with the second request to the second computing device. The upstream computing device(s) may send the indication of the second delay parameter when the second processing delay (d₂) meets or exceeds the delay threshold. The upstream computing device(s) may send the indication of the second delay parameter before, with, or after sending the content itself to the second computing device. The upstream computing device(s) may send the indication of the second delay parameter via one or more messages and/or network signaling, such as a CMSD parameter/message as discussed herein. Other examples are possible as well, such as metadata appended to the content that indicates the second delay parameter, a message(s) sent using a protocol(s) associated with the content that indicates the second delay parameter, signaling associated with the content that indicates the second delay parameter, a combination thereof, and/or the like.

At step 750, the first computing device may determine at least one first service metric. For example, the first computing device may determine at least one first service metric based on the indication of the first delay parameter. The at least one first service metric may be a quality of service measurement, a quality of experience measurement, a bandwidth measurement, a throughput measurement related to receiving the content, a combination thereof, and/or the like. The first computing device may determine the at least one first service metric according to adaptation logic in order to make rate adaptation decisions, such as determining whether to request an alternative representation of the content (e.g., a differing resolution and/or bitrate).

The at least one first service metric may cause the first computing device make to a rate adaptation decision(s) that causes the first computing device to request a further portion(s) of the content (and/or other content) from another source(s) rather than from the upstream computing device(s). Additionally, or in the alternative, the first computing device may request a further portion(s) of the content (and/or other content) at a different representation (e.g., a lower or higher quality level/bitrate) based on the at least one first service metric. Other examples are possible as well.

At step 760, the second computing device may determine at least one second service metric. For example, the second computing device may determine at least one second service metric based on the indication of the second delay parameter. The at least one second service metric may be a quality of service measurement, a quality of experience measurement, a bandwidth measurement, a throughput measurement related to receiving the content, a combination thereof, and/or the like. The second computing device may determine the at least one second service metric according to adaptation logic in order to make rate adaptation decisions, such as determining whether to request an alternative representation of the content (e.g., a differing resolution and/or bitrate).

The at least one second service metric may cause the second computing device make to a rate adaptation decision(s) that causes the second computing device to request a further portion(s) of the content (and/or other content) from another source(s) rather than from the upstream computing device(s). Additionally, or in the alternative, the second computing device may request a further portion(s) of the content (and/or other content) at a different representation (e.g., a lower or higher quality level/bitrate) based on the at least one second service metric. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, at a first computing device, a request for content;
determining, based on a processing delay associated with the request, at least one delay parameter indicative of the processing delay; and
sending, to a second computing device, the content and the at least one delay parameter.

2. The method of claim 1, further comprising:
determining, at a first time, based on the content not being available at the first computing device or a cache associated with the first computing device, the processing delay; and
retrieving, at a second time, the content from at least one other computing device, wherein the at least one delay parameter is indicative of:
the content not being available at the first computing device or the cache associated with the first computing device, and
an amount of time between the first time and the second time.

3. The method of claim 1, further comprising:
determining, based on a prioritization scheme, a processing priority for the request, wherein the processing delay is based on the processing priority; and
determining, at a first time, based on the processing priority, that the request is to be processed, wherein the content and the at least one delay parameter are sent at a second time, and wherein the at least one delay parameter is indicative of the processing priority and an amount of time between the first time and the second time.

4. The method of claim 3, further comprising:
determining, prior to be the request being processed, that the content is not available at the first computing device or a cache associated with the first computing device; and
retrieving, prior to the second time, the content from at least one other computing device.

5. The method of claim 3, wherein the second computing device comprises a playback buffer, wherein the request comprises an indication of a status of the playback buffer, and wherein determining the processing priority for the request comprises:
determining, based on the status of the playback buffer, a buffer starvation time; and
determining, based on the buffer starvation time and the prioritization scheme, the processing priority.

6. The method of claim 1, wherein the at least one delay parameter is indicative of an amount of time associated with the processing delay, and wherein sending the content and the at least one delay parameter comprises:
determining that the amount of time associated with the processing delay meets or exceeds a threshold amount; and
sending, based on the amount of time meeting or exceeding the threshold amount, the at least one delay parameter to the second computing device.

7. The method of claim 1, further comprising:
determining, by the second computing device, based on the at least one delay parameter, a service metric associated with receiving the content; and
determining, by the second computing device, based on the service metric, that one or more of:
the content is to be requested from a content source that differs from the first computing device,
a different representation of the content is to be requested, or
the content is to be requested at a different bitrate.

8. A method comprising:
determining, for a first content request of a plurality of content requests, a first processing delay associated with the first content request;
determining, for a second content request of the plurality of content requests, a second processing delay associated with the second content request;
sending, based on the first processing delay meeting or exceeding a delay threshold, at least one delay parameter and content associated with the first content request; and
sending, based on the second processing delay not meeting or exceeding the delay threshold, content associated with the second content request.

9. The method of claim 8, wherein sending the at least one delay parameter and the content associated with the first content request comprises:
determining a first amount of time associated with the first processing delay, wherein the first amount of time meets or exceeds the delay threshold;
determining, based on the first amount of time meeting or exceeding the delay threshold, the at least one delay parameter, wherein the at least one delay parameter is indicative of the first amount of time; and
sending, to a client device associated with the first content request, the at least one delay parameter and the content associated with the first content request.

10. The method of claim 8, wherein sending the content associated with the second content request comprises:
determining a second amount of time associated with the second processing delay, wherein the second amount of time does not meet or exceed the delay threshold;
determining, based on the second amount of time not meeting or exceeding the delay threshold, that the content associated with the second request is to be sent without a delay parameter; and
sending, to a client device associated with the second content request, the content associated with the second content request.

11. The method of claim 8, further comprising:
determining, at a first time, based on the content associated with the first content request not being available, the first processing delay; and
retrieving, at a second time, the content associated with the first content request, wherein the at least one delay parameter is indicative of an amount of time between the first time and the second time.

12. The method of claim 8, further comprising:
determining, at a first time, based on the content associated with the second content request not being available, the second processing delay; and
retrieving, at a second time, the content associated with the first second request, wherein an amount of time between the first time and the second time does not meet or exceed the delay threshold.

13. The method of claim 8, further comprising:
determining, based on a prioritization scheme, a processing priority for the first content request, wherein the first processing delay is based on the processing priority; and
determining, at a first time, based on the processing priority, that the first content request is to be processed, wherein the at least one delay parameter and the content associated with the first content request are sent at a second time, and wherein the at least one delay parameter is indicative of the processing priority and an amount of time between the first time and the second time.

14. The method of claim 8, wherein the second content request comprises an indication of a status of a playback buffer, and wherein the method further comprises:
determining, based on the status of the playback buffer, a buffer starvation time; and
determining, based on the buffer starvation time and a prioritization scheme, a processing priority for the second content request, wherein an amount of time between receiving the second content request and processing the second request according to the processing priority is less than the buffer starvation time, and wherein the amount of time does not meet or exceed the delay threshold.

15. A method comprising:
receiving, by a first computing device from a second computing device, a response to a first content request, wherein the response comprises a first portion of content and at least one delay parameter;
determining, based on the at least one delay parameter, a service metric associated with receiving the content; and
sending, based on the service metric, a second content request associated with a second portion of the content, wherein the second content request is at least one of: sent to a third computing device or associated with a bitrate that differs from the first content request.

16. The method of claim 15, wherein the at least one delay parameter is indicative of an amount of time for a processing delay associated with the first content request.

17. The method of claim 16, wherein determining the service metric comprises:
determining, based on the amount of time and a buffer starvation time, the service metric, wherein the buffer starvation time is associated with a time at which a playback buffer associated with the first computing device will become empty.

18. The method of claim 15, further comprising: determining, based on the service metric, that the second content request is to be sent to the third computing device.

19. The method of claim 15, further comprising:
determining, by the second computing device, that the first portion of the content is not available at the first computing device or a cache associated with the first computing device; and
retrieving, from the third computing device, the first portion of the content.

20. The method of claim 15, wherein the service metric comprises at least one of:
an estimated amount of time for receiving further portions of the content;
a rate adaptation metric;
a buffer starvation time;
a quality of service metric; or
a quality of experience metric.
